(19) United States
(12) Patent Application Publication
(10) Pub. No.: US 2015/0311622 A1
(43) Pub. Date: Oct. 29, 2015

(54) CONNECTOR SHELL USED IN A LIGHTNING CONNECTOR

(71) Applicant: Cheng Uei Precision Industry Co., Ltd., New Taipei City (TW)

(72) Inventor: DA-YONG KUO, New Taipei City (TW)

(73) Assignee: Cheng Uei Precision Industry Co., Ltd., New Taipei City (TW)

(21) Appl. No.: 14/262,679

(22) Filed: Apr. 25, 2014

(51) Int. Cl. H01R 13/506; H01R 13/6593

(52) U.S. Cl. CPC H01R 13/506; H01R 13/6593

(57) ABSTRACT

A connector shell includes an upper shell and a lower shell. The upper shell has a top plate positioned horizontally. Two opposite side edges of the top plate are bent downward and extend vertically to form two first side plates each defining a plurality of locking holes. The lower shell has a bottom plate positioned horizontally. Two opposite side edges of the bottom plate are bent upward and extend vertically to form two second side plates of which each protrudes outward to form a plurality of locking blocks corresponding to the locking holes of the upper shell. The upper shell and the lower shell are coupled and covered with each other with the first side plates abutting against outer sides of the second side plates. The locking blocks are buckled in the locking holes.

### BACKGROUND OF THE INVENTION

1. Field of the Invention

The present invention relates to a connector shell, and more particularly to a connector shell used in a lightning connector.

2. the Related Art

Currently, the electronic information products have developed various specifications of the date transmission communication protocol. Accordingly, different types of electrical connectors are manufactured on the basis of the different specifications of the communication protocol. A lightning connector as one type of the electrical connector is an eight-pin data and power connector which is non-directional, can be inserted with either side facing up and has adaptive and high-speed signal transmission functions, so it is popularly and widely used in our daily life, which greatly facilitates the connection of data signals and electrical signals. With the miniaturization development of electronic products, the lightning connector becomes smaller and smaller, and accordingly, a shell of the lightning connector is also in line with the trend of miniaturization development. The shell of a conventional lightning connector is composed of an upper shell and a lower shell covering with each other. In detail, two opposite side edges of the upper shell extend horizontally outward to form at least two first soldering plates, and two opposite side edges of the lower shell extend horizontally outward to form at least two second soldering plates arranged in accordance with the first soldering plates. In assembly, the upper shell and the lower shell are covered with each other and fastened together by virtue of the first soldering plates and the second soldering plates being soldered with one another.

However, the soldering plates horizontally formed at two opposite sides of the shell broaden out the whole structure of the lightning connector, which causes the failure of the foregoing lightning connector in the miniaturization development. And the first soldering plates of the upper shell and the second soldering plates of the lower shell are apt to have position error on account of no positioning mechanism.

### SUMMARY OF THE INVENTION

Accordingly, an object of the present invention is to provide a connector shell used in a lightning connector which is an eight-pin connector. The connector shell includes an upper shell and a lower shell. The upper shell has a top plate positioned horizontally. A front edge of the top plate is slanted downward and forward and then extends forward to form a first holding portion. Two opposite side edges of the top plate are bent downward and extend vertically to form two first side plates. Each of the first side plates defines a plurality of locking holes. The lower shell has a bottom plate positioned horizontally. A front edge of the bottom plate is slanted upward and forward and then extends forward to form a second holding portion. Two opposite side edges of the bottom plate are bent upward and extend vertically to form two second side plates. Each of the second side plates protrudes outward to form a plurality of locking blocks corresponding to the locking holes of the upper shell. The upper shell and the lower shell are coupled and covered with each other with the first side plates abutting against outer sides of the second side plates. The locking blocks are buckled in the locking holes and the first holding portion apart faces the second holding portion.

As described above, the first side plates and the second side plates are perpendicular to the top plate and the bottom plate respectively and are vertically against with one another, so that decreases the whole width of the connector shell and further miniaturizes the whole structure of the lightning connector. Meanwhile, the buckle-fit between the locking holes of the first side plates and the locking blocks of the second side plates achieves quick and accurate position and couple of the upper shell and the lower shell.

### BRIEF DESCRIPTION OF THE DRAWINGS

The present invention will be apparent to those skilled in the art by reading the following description thereof, with reference to the attached drawings, in which:

FIG. 1 is a perspective view showing a connector shell according to an embodiment of the present invention is used in a lightning connector;

FIG. 2 is a perspective view of the connector shell shown in FIG. 1; and

FIG. 3 is an exploded view of the connector shell shown in FIG. 2.

### DETAILED DESCRIPTION OF THE EMBODIMENT

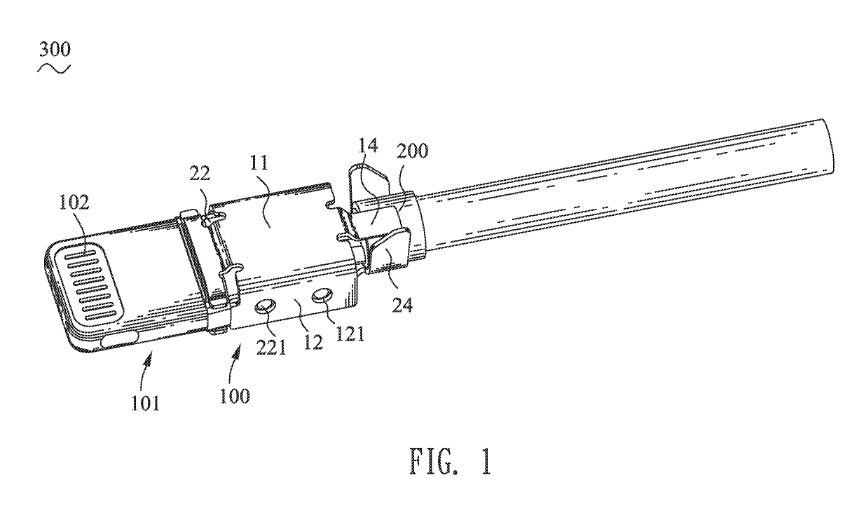

Referring to FIG. 1, a connector shell 100 in accordance with an embodiment of the present invention is used in a lightning connector 300. The lightning connector 300 is an eight-pin data and power connector which is non-directional, can be inserted with either side facing up and has adaptive and high-speed signal transmission functions. Besides, the lightning connector 300 has a small size that it can firmly stick in the slot of light device. The lightning connector 300 includes an insulating body 101, a plurality of terminals 102 disposed in the insulating body 101 and the connector shell 100 worn around the insulating body 101, wherein the terminals 102 are divided into two groups of which each has eight pins, the two groups of the eight pins of terminals 102 are identical with each other and are respectively exposed on two opposite surfaces of the insulating body 101. A rear end of the lightning connector 300 is connected with a transmission line (not labeled). A front end of the transmission line is coated with a conductive copper foil 200 electrically connecting with a rear end of the connector shell 100.

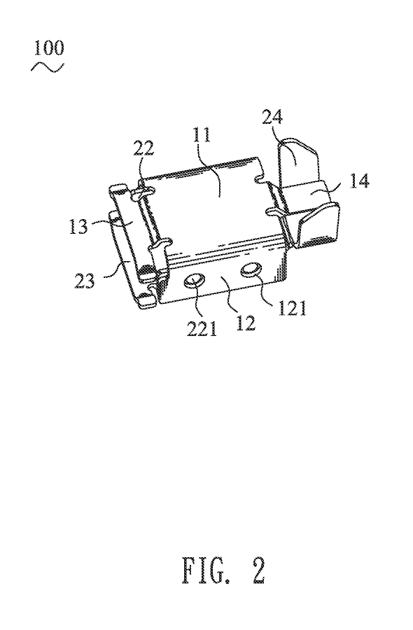

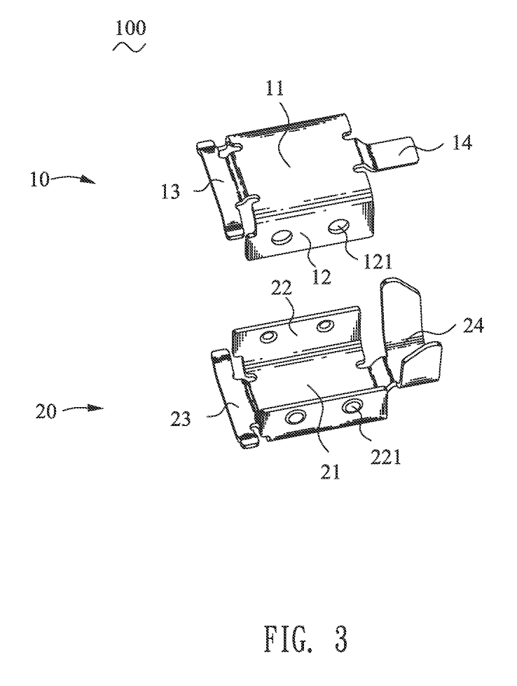

Referring to FIG. 2 and FIG. 3, the connector shell 100 is made by sheet metal manufacture processing. The connector shell 100 includes an upper shell 10 and a lower shell 20. The upper shell 10 has a top plate 11 positioned horizontally. Two opposite side edges of the top plate 11 are bent downward and extend vertically to form two first side plates 12. Each of the first side plates 12 defines a plurality of locking holes 121. A front edge of the top plate 11 is slanted downward and forward and then extends forward to form a first holding portion 13. A contact slice 14 slants downward and backward and then extends backward from a middle of a rear edge of the top plate 11 of the upper shell 10.

The lower shell 20 has a bottom plate 21 positioned horizontally. Two opposite side edges of the bottom plate 21 are bent upward and extend vertically to form two second side plates 22. Each of the second side plates 22 protrudes outward to form a plurality of locking blocks 221 corresponding to the locking holes 121 of the upper shell 10. A front edge of the bottom plate 21 is slanted upward and forward and then extends forward to form a second holding portion 23. A middle of a rear edge of the bottom plate 21 of the lower shell 20 is slanted upward and backward and then extends backward with a tail end being rolled up to form a U-shaped contact portion 24.

Referring to FIG. 1, FIG. 2 and FIG. 3, when the connector shell 100 is in assembly, the upper shell 10 and the lower shell 20 are coupled and covered with each other with the first side plates 12 abutting against outer sides of the second side plates 22. The locking blocks 221 are buckled in the locking holes 121 and the first holding portion 13 apart faces the second holding portion 23, wherein the first holding portion 13 and the second holding portion 23 are against two opposites sides of the insulating body 101 and firmly hold the connector shell 100 and the insulating body 101 together. The contact slice 14 of the upper shell 10 is located in the contact portion 24 of the lower shell 20. The front end of the transmission line is sandwiched between the contact slice 14 and the contact portion 24 and electrically connected with the terminals 102, and the conductive copper foil 200 of the transmission line electrically contacts with the contact slice 14 and the contact portion 24. Meanwhile, in order to strengthen the assembly firmness of the first side plates 12 and the second side plates 22, the locking blocks 221 of the lower shell 20 are further spot welded in the locking holes 121 of the upper shell 10.

As described above, the first side plates 12 and the second side plates 22 are perpendicular to the top plate 11 and the bottom plate 21 respectively and are vertically against with one another, so that decreases the whole width of the connector shell 100 and further miniaturizes the whole structure of the lightning connector 300. Meanwhile, the buckle-fit between the locking holes 121 of the first side plates 12 and the locking blocks 221 of the second side plates 22 achieves quick and accurate position and couple of the upper shell 10 and the lower shell 20.

What is claimed is:

1. A connector shell used in a lightning connector which is an eight-pin connector, comprising:
an upper shell having a top plate positioned horizontally, a front edge of the top plate being slanted downward and forward and then extending forward to form a first holding portion, two opposite side edges of the top plate being bent downward and extending vertically to form two first side plates, each of the first side plates defining a plurality of locking holes; and
a lower shell having a bottom plate positioned horizontally, a front edge of the bottom plate being slanted upward and forward and then extending forward to form a second holding portion, two opposite side edges of the bottom plate being bent upward and extending vertically to form two second side plates, each of the second side plates protruding outward to form a plurality of locking blocks corresponding to the locking holes of the upper shell, wherein the upper shell and the lower shell are coupled and covered with each other with the first side plates abutting against outer sides of the second side plates, the locking blocks being buckled in the locking holes and the first holding portion apart facing the second holding portion.

2. The connector shell as claimed in claim 1, wherein the locking blocks of the lower shell are further spot welded in the locking holes of the upper shell.

3. The connector shell as claimed in claim 1, wherein a rear end of the lighting connector is connected with a transmission line, a front end of the transmission line is coated with a conductive copper foil, a contact slice slants downward and backward and then extends backward from a middle of a rear edge of the top plate of the upper shell, a middle of a rear edge of the bottom plate of the lower shell is slanted upward and backward and then extends backward with a tail end being rolled up to form a U-shaped contact portion, the contact slice of the upper shell is located in the contact portion of the lower shell, the front end of the transmission line is sandwiched between the contact portion and the contact slice, and the conductive copper foil of the transmission line electrically contacts with the contact slice and the contact portion.
